(19) United States
(12) Patent Application Publication
(10) Pub. No.: US 2011/0197773 A1
(43) Pub. Date: Aug. 18, 2011

(54) Device and Method for Compressing Compressible Material into a Bale

(76) Inventor: Christopher S. Purdy, Campobello, SC (US)

(21) Appl. No.: 12/704,772

(22) Filed: Feb. 12, 2010

(51) Int. Cl. B30B 9/30; B30B 13/00; B30B 15/32; B30B 15/00

(52) U.S. Cl. 100/35; 100/178; 100/218; 100/215

(57) ABSTRACT

A device and method for compressing compressible material into a bale are provided. According to certain aspects of the disclosure, the device may include a flame, a staging bin, a feed bin, a first compression chamber, a second compression chamber, and a compression ram. The staging bin may be configured to accommodate the compressible material. The feed bin may be configured to receive the compressible material from the staging bin. The first compression chamber and the second compression chamber may be mounted to the frame so as to be rotatable about a substantially horizontal axis between a compression position and a transfer position. The compression ram may be configured to load the compressible material from the feed bin into a respective one of the first or second compression chambers in the compression position and compress the compressible material into the bale within the respective compression chamber.

### TECHNICAL FIELD

The present disclosure relates to devices and methods for compressing compressible material into a bale.

### BACKGROUND

It has long been known in the baling and packaging fields to compress various compressible materials into high-density bales, in order to simplify the handling of the materials, reduce the space needed for storing the materials, and reduce the shipping costs associated with the materials. For example, a compressible material may be compressed into a high-density bale within a packaging container for shipment or storage, or a compressible material may be compressed into a high-density bale and then packaged for shipment or storage.

Various devices and methods are known in the art for compressing compressible materials into bales. For example, horizontal and vertical balers are commonly used to compress compressible materials into bales. A typical baler operates by first accepting a predetermined amount of a compressible material in a chamber, then compressing the compressible material into a bale, and then ejecting this bale. The bale can be packaged before or after it is ejected from the baler.

Although the baling devices currently known in the art can effectively compress compressible materials into bales, the baling process of known baling devices is relatively slow and inefficient. For example, in many known baling devices, the steps of loading compressible material, compressing the compressible material into a bale, and ejecting the bale must each be performed separately and sequentially in order for a bale to be produced. Further, there may be significant lag times between steps such as, for example, while compressible material is obtained, while the proper amount of compressible material to be baled is determined, and while this amount of compressible material is loaded into the baling device. In view of the above, a need currently exists for a fast and efficient baling method, and for a baling device that allows for fast and efficient baling of compressible materials.

### SUMMARY

Aspects and advantages of the invention will be set forth in part in the following description, or may be obvious from the description, or may be learned through practice of the invention.

According to certain aspects of the disclosure, a baling device for compressing compressible material into a bale is provided. The device may include, for example, a frame, a staging bin, a feed bin, a first compression chamber, a second compression chamber, and a compression ram. The staging bin may be mounted to the frame and configured to accommodate the compressible material. The feed bin may be mounted to the frame and configured to receive the compressible material from the staging bin. The first compression chamber and the second compression chamber may be mounted to the frame so as to be rotatable about a substantially horizontal axis, and may be rotatable about the axis between a compression position adjacent the feed bin and a transfer position spaced from the feed bin. The compression ram may be configured to load the compressible material from the feed bin into a respective one of the first or second compression chambers when the respective compression chamber is disposed in the compression position. The compression ram may further be configured to compress the compressible material into the bale within the respective compression chamber.

If desired, the baling device may further include a transfer ram. The transfer ram may be configured to eject the bale from a respective one of the first or second compression chambers when the respective compression chamber is disposed in the transfer position.

According to other aspects of the disclosure, a method for compressing compressible material into a bale is provided. The method may include, for example, loading compressible material into a staging bin, transferring the compressible material from the staging bin into a feed bin, and loading the compressible material from the feed bin into a compression chamber disposed in a compression position adjacent the feed bin. The compression chamber may be one of a first compression chamber and a second compression chamber. The first compression chamber and second compression chamber may be rotatable about a substantially horizontal axis between the compression position and a transfer position spaced from the feed bin. The method may further include compressing the compressible material into the bale within the compression chamber disposed in the compression position, rotating the compression chamber about the axis to the transfer position, and ejecting the bale from the compression chamber disposed in the transfer position.

If desired, the loading of the compressible material from the feed bin into the compression chamber disposed in the compression position and the compressing of the compressible material may occur simultaneously.

If desired, the ejecting of the bale from the respective first or second compression chamber disposed in the transfer position and the loading of the compressible material from the feed bin into the respective second or first compression chamber disposed in the compression position may occur simultaneously.

If desired, the loading of the compressible material from the feed bin into the compression chamber disposed in the compression position and the rotating of the compression chamber about the axis to the transfer position may occur in sequence.

if desired, the transferring of the compressible material into the feed bin and the loading of the compressible material from the feed bin into the compression chamber disposed in the compression position may occur in sequence.

These and other features, aspects and advantages of the present invention will become better understood with reference to the following description and appended claims. The accompanying drawings, which are incorporated in and constitute a part of this specification, illustrate various aspects of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIGS. 1A through 1E provide side views of one aspect of the baling device of the present invention during various steps of the baling process;

FIG. 2 provides a sectional view of one aspect of the staging bin and feed bin of the present invention along the line 2-2 of FIG. 1A.

FIG. 3 provides a perspective view of one aspect of the first and second compression chambers of the present invention.

### DETAILED DESCRIPTION

Reference now will be made in detail to various aspects of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one aspect can be used with another aspect to yield a still further aspect. Thus, it is intended that the present invention covers such modifications and variations as come within the scope of the appended claims and their equivalents.

In general, the present disclosure is directed to a baling device for compressing compressible material into a bale, and to a method for compressing compressible material into a bale. The baling device may be utilized to compress and bale a wide variety of compressible materials such as, for example, wood shavings, fiber cellulose, peat moss, blown insulation, or animal feed. In accordance with the present disclosure, various steps of the baling process may be performed simultaneously, greatly increasing the speed and efficiency of the baling process. For example, according to certain aspects of the disclosure, the baling device may allow compressible material to be simultaneously loaded and compressed into a bale. According to other aspects of the disclosure, the baling device may allow a bale to be ejected from one compression chamber simultaneously with compressible material being loaded and compressed into a bale in another compression chamber. Further in accordance with the present disclosure, the baling device and process may provide for the staging of compressible material, eliminating lag time in the baling process. Thus, the baling device of the present disclosure may allow for fast and efficient baling of compressible materials.

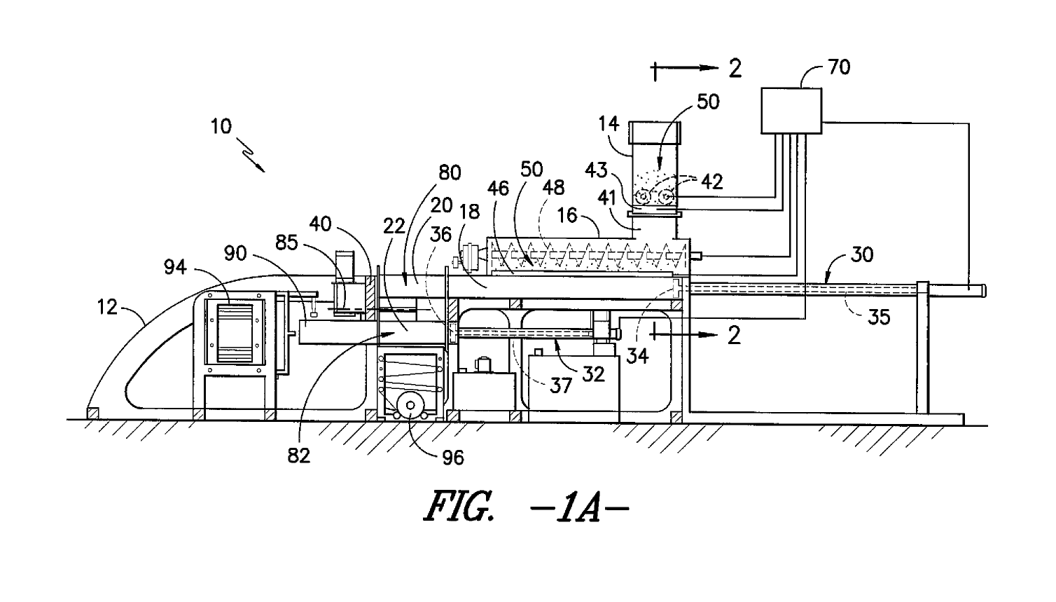

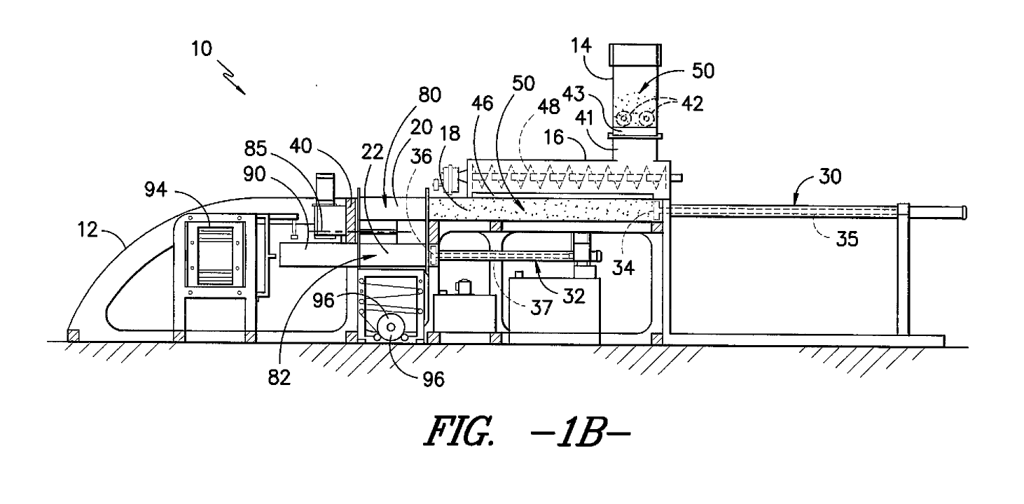

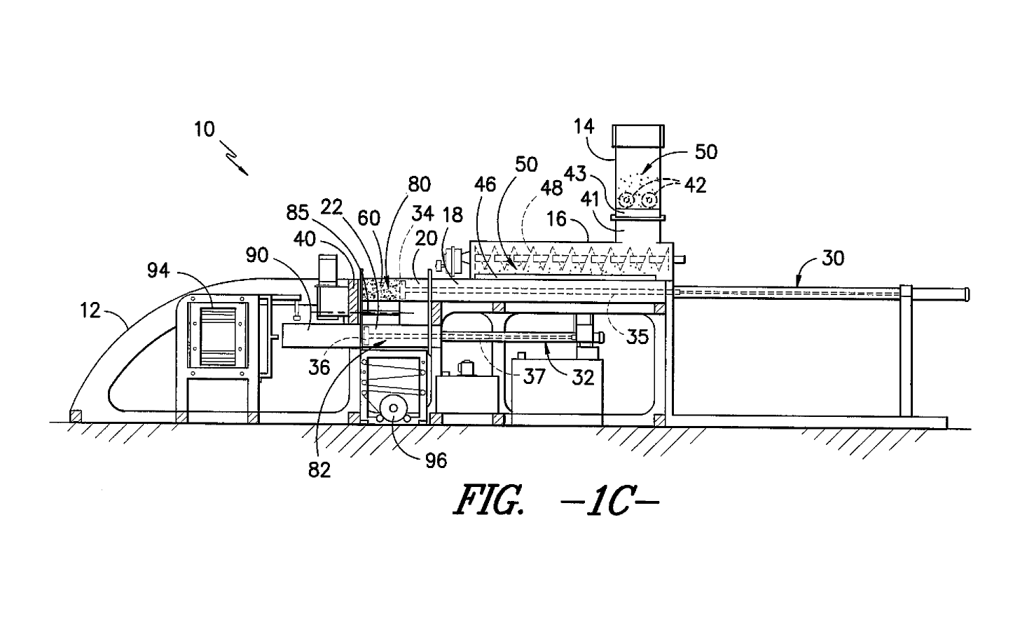

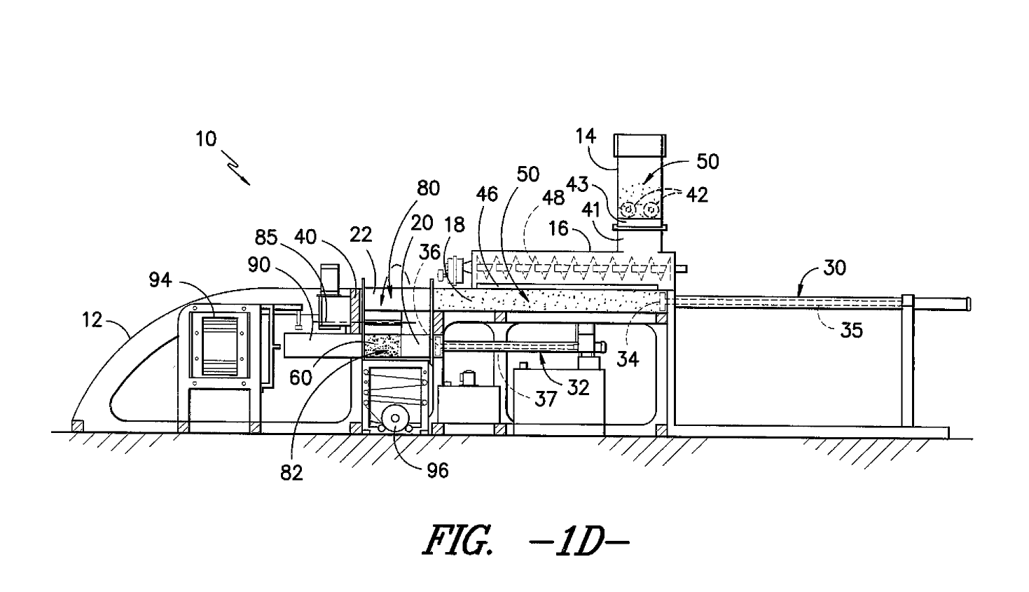

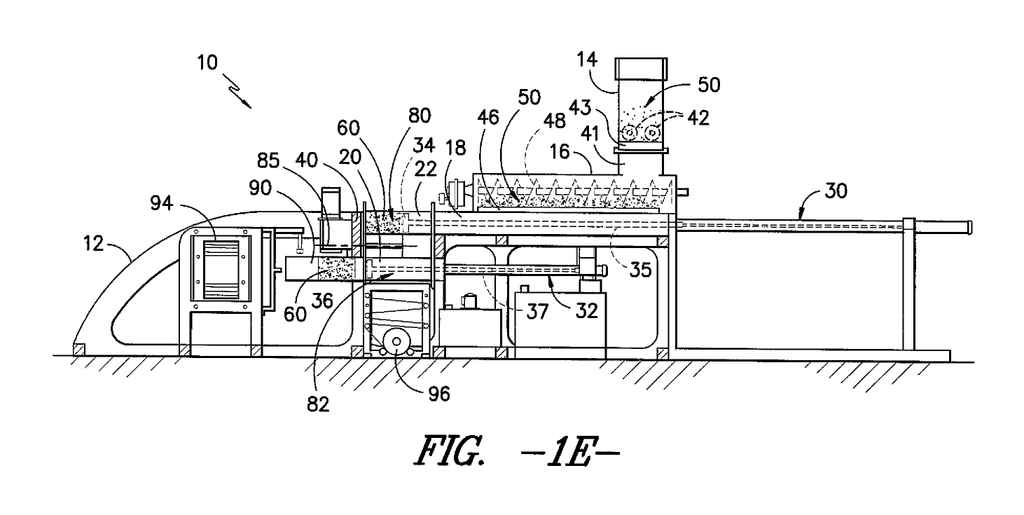

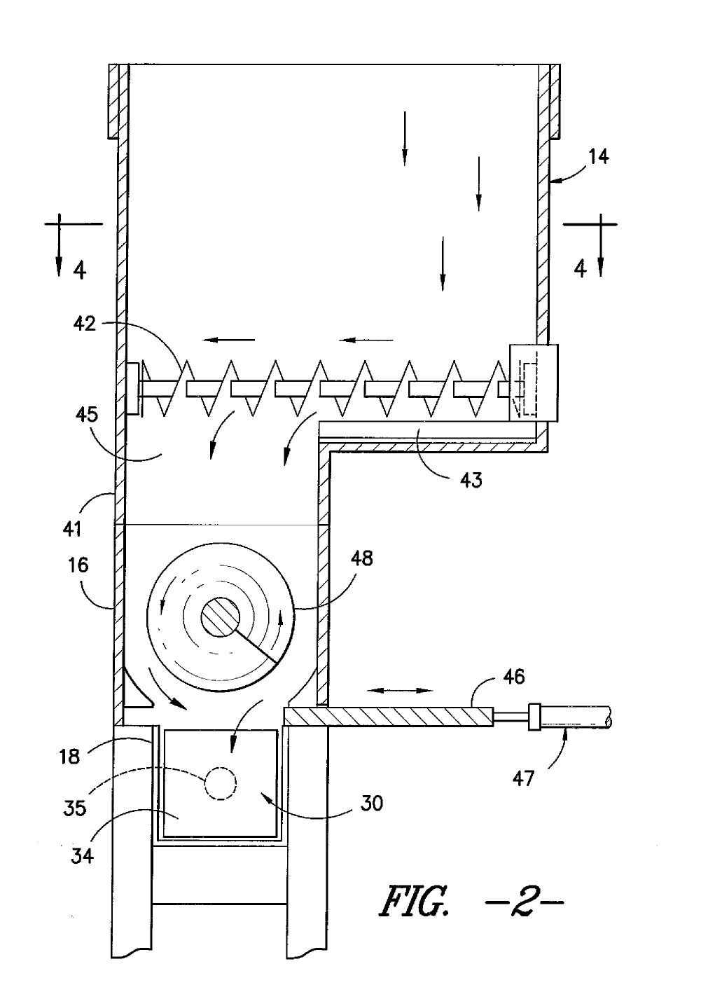

Referring to FIG. 1A, one example of a baling device 10 is illustrated. The device 10 may include a frame 12, a metering bin 14, a staging bin 16, and a feed bin 18. The baling device 10 may further include more than one metering bin 14, staging bin 16, and feed bin 18.

The metering bin 14 may be mounted to the frame 12. The metering bin 14 may be configured to determine an amount of compressible material 50 to be compressed in the baling device 10. For example, the metering bin 14 may include a weighing device 43, such as a scale, a load cell, or any other weighing device known in the art. Further, the metering bin 14 may include more than one weighing device. For example, in one embodiment, the metering bin 14 may include three load cells. The weighing device or devices 43 may be configured to determine the amount of compressible material 50 contained within the metering bin 14. For example, compressible material 50 may be loaded into the metering bin 14, and this compressible material 50 may contact the weighing device 43. The weighing device 43 may determine the amount of compressible material 50 contained within the metering bin 14 by, for example, calculating the weight of the compressible material 50 that is in contact with the weighing device 43.

The weighing device 43 may further be programmed with a predetermined amount, such as with a predetermined weight or with a predetermined amount corresponding to the desired size of a bale 60 of compressible material 50 to be produced by the baling device 10. When the amount of compressible material 50 contained within the metering bin 14 matches the predetermined amount, the weighing device 43 may be programmed to communicate this information to other components of the baling device 10. For example, in one embodiment, the weighing device 43 may be programmed to communicate with a transfer mechanism 42, as discussed below. In another embodiment, the weighing device 43 may be programmed to communicate with a controller 70, as discussed below, and the controller 70 may be configured to communicate with the transfer mechanism 42. Upon receiving a communication from the weighing device 43 or the controller 70, the transfer mechanism 42 may operate to transfer the amount of compressible material 50 to be compressed to the staging bin 16.

The metering bin 14 may further be configured to selectively transfer the amount of the compressible material 50 to be compressed to the staging bin 16. As shown in FIG. 5, for example, the metering bin 14 may include a chute 41 for allowing compressible material 50 to pass from the metering bin 14 to the staging bin 16. The chute 41 may define a bore 45 therethrough. If desired, the cross-sectional profile of the bore 45 may be rectangular. Further, if desired, the cross-sectional profiles of the bore 45 may be circular, triangular, or any other cross-sectional profile known in the art. In one embodiment, the bore 45 may have a cross-sectional area that is smaller than the cross-sectional area of the metering bin 14.

The metering bin 14 may also include at least one transfer mechanism 42 for transferring compressible material 50 in the metering bin 14 to the chute 41. For example, if desired, the transfer mechanism 42 may be an auger, and the auger may rotate in a clockwise or counter-clockwise fashion, drawing the amount of the compressible material 50 to be compressed from the metering bin 14 to the chute 41. The metering bin 14 may further include more than one transfer mechanism 42, such as, for example, more than one auger. It should be understood that the transfer mechanisms 42 of the present disclosure are not limited to augers, but may be any mechanisms known in the art for transferring material, such as conveyors, feed gates, or the like.

The transfer mechanism 42 may be operably connected to a controller 70. The controller 70 may be any commercially available programmable logic controller (“PLC”). For example, if desired, the controller 70 may be a Siemans S7313C-2-DP PLC, or any other suitable PLC known in the art. The controller 70 may be configured to operate the transfer mechanism 42 such that the transfer mechanism 42 transfers compressible material 50 from the metering bin 14 to the staging bin 16. For example, in one embodiment, the controller 70 may be in communication with the weighing device 43 and the transfer mechanism 42. The weighing device 43 may periodically communicate to the controller 70 that a predetermined amount of compressible material 50 is contained within the metering bin 14. The controller 70 may periodically operate the transfer mechanism 42 in response to the communication received from the weighing device 43, such that the transfer mechanism 42 transfers the amount of compressible material to be compressed from the metering bin 14 through the chute 41 into the staging bin 16. In other embodiments, the controller 70 may be configured to operate the transfer mechanism 42 continuously, or periodically at any time as desired. Further, the controller 70 may be configured to operate the transfer mechanism 42 in response to communications from other components of the baling system 10, or in response to an embedded controller program or any embedded controller code, or in response to communications from an operator of the controller 70, such as a human operator.

The staging bin 16 may be mounted to the frame 12. As shown in FIGS. 1A, 1C, and 1E, the staging bin 16 may be configured to accommodate compressible material 50. For example, the staging bin 16 may be configured to accommodate an amount of compressible material 50 to be compressed, as determined by the metering bin 14 and selectively transferred from the metering bin 14 to the staging bin 16.

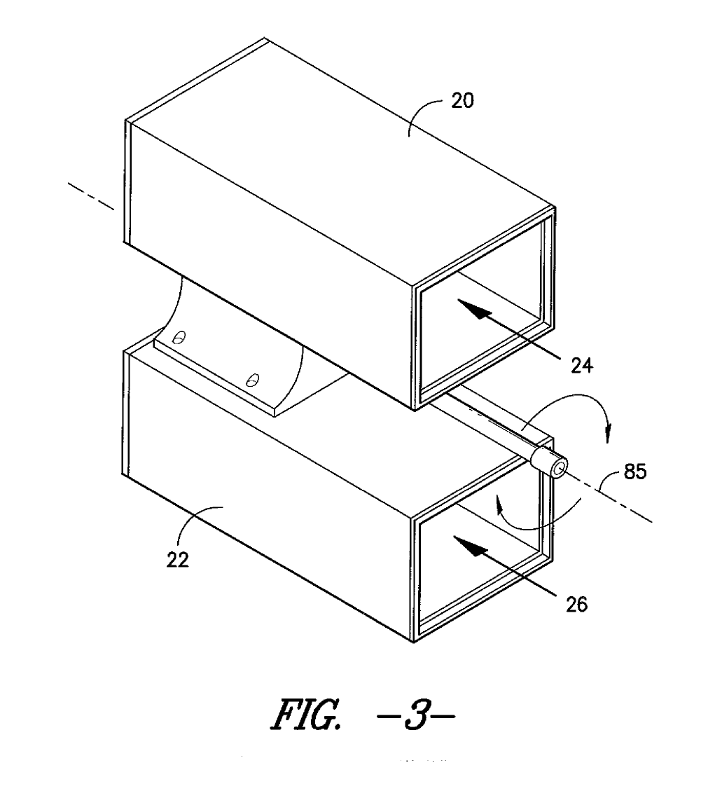

The staging bin 16 may further be configured to selectively transfer the compressible material 50 to the feed bin 18, as shown in FIGS. 1B, 1D, and 2. For example, the staging bin 16 may include a feed gate 46. The feed gate 46 may be configured to selectively transfer the compressible material 50 to the feed bin 18. For example, the feed gate 46 may be configured to reciprocate between an open position and a closed position, selectively transferring the compressible material 50 to the feed bin 18. If desired, the feed gate 46 may be a laterally reciprocating door or a rotationally reciprocating door. It should be understood that the feed gate 46 is not limited to laterally or rotationally reciprocating doors, and may be any device that is suitable for selectively transferring material from one bin to another.

The staging bin 16 may include at least one reciprocating device 47 (see FIG. 2). The reciprocating device 47 may be configured to operate the feed gate 46 in a reciprocating fashion. For example, the reciprocating device 47 may be a pneumatic piston or a hydraulic piston. It should be understood that the reciprocating device is not limited to pneumatic and hydraulic pistons, and may be any device suitable to operate the feed gate 46 in a reciprocating fashion.

The feed gate 46 and the at least one reciprocating device 47 may be operably connected to controller 70. The controller 70 may be configured to operate the feed gate 46 such that the feed gate 46 selectively transfers the compressible material 50 to the feed bin 18. For example, the controller 70 may be configured to operate the feed gate 46 in response to communications from other components of the baling system 10, or in response to an embedded controller program or any embedded controller code, or in response to communications from an operator of the controller 70, such as a human operator.

The staging bin 16 may further include at least one spreading mechanism 48. The spreading mechanism 48 may be configured to distribute the compressible material 50 within the staging bin 16. For example, if desired, the spreading mechanism 48 may be an auger, and the auger may rotate in a clockwise or counter-clockwise fashion, distributing the compressible material 50 within the staging bin 16. The staging bin 16 may further include more than one spreading mechanism 48, such as, for example, more than one auger. It should be understood that the spreading mechanisms 48 of the present disclosure are not limited to augers, but may be any mechanisms known in the art for distributing material.

The spreading mechanism 48 may be operably connected to the controller 70. The controller may he configured to operate the spreading mechanism 48 such that the spreading mechanism 48 distributes the compressible material 50 within the staging bin 16. For example, the controller 70 may be configured to operate the spreading mechanism 48 in response to communications from other components of the baling system 10, or in response to an embedded controller program or any embedded controller code, or in response to communications from an operator of the controller 70, such as a human operator.

The feed bin 18 may be mounted to the frame 12. The feed bin 18 may be configured to receive the compressible material 50 from the staging bin 16. For example, the feed gate 46 of the staging bin 16 may be configured to selectively transfer the compressible material 50 from the staging bin 16 to the feed bin 18. For example, the feed gate 46 may be a laterally reciprocating door, and the compressible material 50 may be transferred from the staging bin 16 to the feed bin 18 when the door reciprocates to an open position.

The device 10 may further include a first compression chamber 20 and a second compression chamber 22. The first compression chamber 20 and the second compression chamber 22 may be mounted to the frame 12 so as to be rotatable about an axis 85. For example, the axis 85 may be a substantially horizontal axis. If desired, the first compression chamber 20 and the second compression chamber 22 may be rotatable about the axis 85 between a compression position 80 and a transfer position 82, as shown in FIG. 1D. The compression position 80 may be a position such that the respective first or second compression chamber 20 or 22 is adjacent the feed bin 18. The transfer position 82 may be a position such that the respective first or second compression chamber 20 or 22 is spaced from the feed bin 18.

It should be understood that the first compression chamber 20 and the second compression chamber 22 are not limited to a single first compression chamber 20 and a single second compression chamber 22, but may be more than one first compression chamber 20 and second compression chamber 22. For example, the device 10 may include a plurality of first compression chambers 20 and second compression chambers 22. The compression chambers 20 and 22 may be rotatable about an axis 85, and may rotate between compression positions and transfer positions, as discussed above. Further, it should be understood that the compression position 80 and the transfer position 82 are not limited to single positions, but may be more than one compression position and transfer position corresponding to the more than one first compression chamber 20 and second compression chamber 22.

The first compression chamber 20 and the second compression chamber 22 may be operably connected to the controller 70. The controller 70 may be configured to operate the first compression chamber 20 and the second compression chamber 22 such that they are rotatable about the axis 85. For example, the controller 70 may be configured to operate the first compression chamber 20 and the second compression chamber 22 in response to communications from other components of the baling system 10, or in response to an embedded controller program or any embedded controller code, or in response to communications from an operator of the controller 70, such as a human operator.

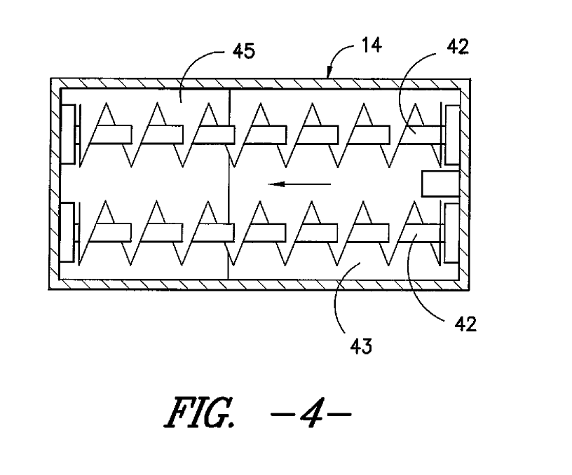

As shown in FIG. 3, the first and second compression chambers 20 and 22 may each define a bore 24 and 26 therethrough. The bores 24 and 26 may have substantially identical cross-sectional profiles. If desired, for example, the cross-sectional profiles of the bores 24 and 26 may be rectangular. Further, if desired, the cross-sectional profiles of the bores 24 and 26 may be circular, triangular, or any other cross-sectional profile known in the art.

The baling device 10 may further include a compression rain 30. The compression ram 30 may be configured to load the compressible material 50 from the feed bin 18 into a respective one of the first or second compression chambers 20 or 22 when the respective compression chamber is disposed in the compression position 80. The compression rain 30 may further be configured to compress the compressible material 50 into a bale 60 within the respective compression chamber.

It should be understood that the compression ram 30 is not limited to a single compression ram, but may be more than one compression ram 30. For example, the device 10 may include more than one compression ram 30 corresponding to more than one compression chambers 20 and 22 and compression positions 80.

The compression ram 30 may include a head 34 and a shaft 35. The head 34 may be configured to reciprocate between a first position and a second position. The first position may be a position such that the head 34 is disposed within the feed bin 18, as shown in FIGS. 1A, 1B, and 1D. The second position may be a position such that the head 34 is disposed within a compression chamber, as shown in FIGS. 1C and 1E. For example, in the second position, the head 34 may be disposed within the respective one of the first or second compression chambers 20 and 22 when the respective compression chamber is disposed in the compression position 80.

The reciprocating motion of the compression rain 30 may be a lateral reciprocating motion. For example, the compression ram 30 may be configured to reciprocate in an intermittent back-and-forth motion between the first position and the second position, such that the reciprocating motion is a motion parallel to the axis 85 about which the compression chambers 20 and 22 are rotatable.

The compression ram 30 may be operably connected to the controller 70. The controller 70 may be configured to operate the compression ram 30 to load and compress the compressible material 50. For example, the controller 70 may be configured to operate the compression rain 30 in response to communications from other components of the baling system 10, or in response to an embedded controller program or any embedded controller code, or in response to communications from an operator of the controller 70, such as a human operator.

The compression ram 30 may be configured to load the compressible material 50 from the feed bin 18 into a respective one of the first or second compression chambers 20 or 22 when the respective compression chamber is disposed in the compression position 80. For example, the head 34 of the compression ram 30 may be configured to reciprocate between the first position and the second position. As the head 34 reciprocates from the first position to the second position, the head 34 may contact the compressible material 50 within the feed bin 18, causing the compressible material 50 to move from the feed bin 18 into the respective compression chamber 20 or 22, thereby loading the compressible material 50 from the feed bin 18 into the respective compression chamber 20 or 22.

Further, the compression rain 30 may be configured to compress the compressible material 50 into a bale 60 within the respective compression chamber 20 or 22 disposed in the compression position 80. For example, the baling device 10 may include a compression barrier 40. The compression barrier 40 may be fixedly mounted to the frame 12. Further, the compression barrier 40 may be situated adjacent the respective one of the first or second compression chambers 20 and 22 when the respective compression chamber is disposed in the compression position 80. The compression barrier 40 may be situated such that when the head 34 of the compression ram 30 reciprocates from the first position to the second position, the compressible material 50 is compressed into the bale 60 within the respective compression chamber 20 or 22 by the head 34 against the compression barrier 40.

It should be understood that the compression barrier 40 is not limited to one compression barrier 40, but may be more than one compression barrier 40. For example, the device 10 may include more than one compression barrier 40 corresponding to more than one compression chambers 20 and 22 and compression positions 80.

If desired, the operation of the compression ram 30 to load the compressible material 50 from the feed bin 18 into a respective one of the first or second compression chambers 20 or 22 when the respective compression chamber is disposed in the compression position 80 and the operation of the compression ram 30 to compress the compressible material 50 into a bale 60 within the respective compression chamber may occur simultaneously. For example, as discussed above, the operation of the compression ram 30 to load the compressible material 50 from the feed bin 18 into the respective compression chamber 20 or 22 and the operation of the compression ram 30 to compress the compressible material 50 into a bale 60 within the respective compression chamber 20 or 22 may both occur upon each movement of the head 34 from the first position to the second position.

After the head 34 of the compression rain 30 reciprocates from the first position to the second position, loading and compressing the compressible material 50, the head 34 may then reciprocate from the second position to the first position, withdrawing from the respective compression chamber 20 or 22, such that the head 34 is again disposed in the first position within the feed bin 18. Upon return of the head 34 to the first position, the compression ram 30 may be configured to repeat the reciprocal movement from the first position to the second position, loading and compressing the compressible material 50 into a bale 60.

According to one aspect of the present disclosure, the baling device 10 may include means for simultaneously loading the compressible material 50 from the staging bin 16 and compressing the compressible material 50 into a bale 60. As discussed above, for example, the baling device 10 may include a chamber 20 or 22, a barrier 40, and a ram 30, or a plurality of chambers, barriers, and rams. The ram 30 may be configured to reciprocate between a first position and a second position, and may operate to load the compressible material 50 into the chamber 20 or 22 and to compress the compressible material 50 into a bale 60 within the chamber 20 or 22 upon each movement from the first position to the second position.

The baling device 10 may further include a transfer ram 32. The transfer ram 32 may be configured to eject the bale 60 from the respective one of the first or second compression chambers 20 or 22 when the respective compression chamber is disposed in the transfer position 82.

It should be understood that the transfer ram 32 is not limited to a single transfer rain, but may be more than one transfer ram 32. For example, the device 10 may include more than one transfer ram 32 corresponding to more than one compression chambers 20 and 22 and transfer positions.

The transfer rain 32 may include a head 36 and a shaft 37. The head 36 may be configured to reciprocate between a first position and a second position. The first position may be a position such that the head 36 is disposed adjacent to the respective one of the first or second compression chambers 20 or 22 when the respective compression chamber is disposed in the transfer position 82, as shown in FIGS. 1A, 1B, and 1D. The second position may be a position such that the head 36 is disposed within a compression chamber, as shown in FIGS. 1C and 1E. For example, the second position may be a position such that the transfer ram 32 is disposed within the respective one of the first or second compression chambers 20 or 22 when the respective compression chamber is disposed in the transfer position 82.

The reciprocating motion of the transfer ram 32 may be a lateral reciprocating motion. For example, the transfer ram 32 may be configured to reciprocate in an intermittent back-and-forth motion between the first position and the second position, such that the reciprocating motion is a motion parallel to the axis 85 about which the compression chambers 20 and 22 are rotatable.

The transfer ram 32 may be operably connected to the controller 70. The controller 70 may be configured to operate the transfer ram 32 to eject the bale 60. For example, the controller 70 may be configured to operate the transfer ram 32 in response to communications from other components of the baling system 10, or in response to an embedded controller program or any embedded controller code, or in response to communications from an operator of the controller 70, such as a human operator.

The transfer ram may be configured to eject the bale 60 from the respective one of the first or second compression chambers 20 or 22 when the respective compression chamber is disposed in the transfer position 82. For example, the head 36 of the transfer ram 32 may be configured to reciprocate between the first position and the second position. As the head 36 reciprocates from the first position to the second position, the head 36 may contact the bale 60 within the respective compression chamber 20 or 22 disposed in the transfer position 82, causing the bale 60 to move through the bore 24 or 26 of the respective compression chamber 20 or 22 and eject from the respective compression chamber 20 or 22.

If desired, the operation of the transfer ram 32 to eject the bale 60 from the respective first or second compression chamber 20 or 22 disposed in the transfer position 82 and the operation of the compression ram 30 to load the compressible material 50 from the feed bin 18 into the respective second or first compression chamber 22 or 20 disposed in the compression position 80 may occur simultaneously. For example, the head 34 of the compression ram 30 may be configured to reciprocate between a first position and a second position, loading the compressible material 50 from the feed bin 18 into the respective compression chamber 22 or 20. Further, the head 36 of the transfer ram 32 may be configured to reciprocate between a first position and a second position, ejecting the bale 60 from the respective compression chamber 20 or 22. Movement of the compression ram 30 from a first position to a second position and movement of the transfer ram 32 from a first position to a second position may occur simultaneously. Further, movement of the compression ram 30 from a second position to a first position and movement of the transfer ram 32 from a second position to a first position may occur simultaneously. Upon return of the head 34 of the compression ram 30 and the head 36 of the transfer ram 32 to their respective first positions, the compression ram 30 and the transfer ram 32 may be configured to repeat the reciprocal movement from their respective first positions to their respective second positions, such that the compression ram 30 loads the compressible material 50 into the respective compression chamber 22 or 20 while the transfer ram 32 simultaneously ejects the bale 60 from the respective compression chamber 20 or 22.

According to one aspect of the present disclosure, the baling device 10 may include means for simultaneously loading the compressible material 50 from the staging bin 16 and ejecting the bale 60. As discussed above, for example, the baling device 10 may include a first chamber 20, a second chamber 22, a compression barrier 40, a compression ram 30, and a transfer ram 32, or a plurality of chambers, barriers, and rams. The ram 30 may be configured to reciprocate between a first position and a second position, and may operate to load the compressible material 50 into one of the chamber 20 or 22 upon each movement from the first position to the second position. The rain 32 may be configured to reciprocate between a first position and a second position, and may operate to eject the bale 60 from the other chamber 22 or 20 upon each movement from the first position to the second position.

It should be understood that if desired, the operation of the compression ram 30 to load the compressible material 50 from the feed bin 18 into the respective second or first compression chamber 22 or 20 disposed in the compression position 80, the operation of the compression ram to compress the compressible material 50 into a bale 60 within the respective second or first compression chamber 22 or 20 disposed in the compression position 80, and the operation of the transfer rain 32 to eject the bale 60 from the respective first or second compression chamber 20 or 22 disposed in the transfer position 82 may all occur simultaneously, as discussed in detail above.

Upon ejection of the bale 60 from the respective one of the first or second compression chambers 20 or 22 when the respective compression chamber is disposed in the transfer position 82, the bale 60 may be packaged for shipping or storage. For example, the bale 60 may be ejected into an ejection chamber 90. The ejection chamber 90 may be configured to transfer the bale 60 to, for example, a packaging apparatus. The ejection chamber 90 may define a bore therethrough (not shown). The bore may have a cross-sectional profile that is substantially identical to the cross-sectional profiles of the bores 24 and 26 of the compression chambers 20 and 22. For example, if desired, the cross-sectional profile of the bore may be rectangular. Further, if desired, the cross-sectional profile of the bore may be circular, triangular, or any other cross-sectional profile known in the art.

If desired, the bale 60 may be ejected into a packaging device 94. The packaging device 94 may be any packaging apparatus known in the art. For example, the packaging device 94 may be any conventional form, fill and seal apparatus or any conventional fold and seal apparatus. If desired, the bale 60 may pass through the ejection chamber 90 into the packaging device 94, or the bale 60 may be ejected directly into the packaging device 94. Further, the bale 60 may interact with other packaging apparatus before or after passing through the ejection chamber 90 or the packaging device 94. For example, the bale 60 may interact with wrapping device 96. The wrapping device 96 may be configured to wrap the bale 60 in packaging material.

The present disclosure also describes a method for compressing compressible material into a bale. The method may include, for example, the step of loading the compressible material 50 into a metering bin 14. The step of loading the compressible material 50 into the metering bin 14 may be performed by any loading apparatus known in the art, or may be performed through physical labor, or may be performed through a combination of physical labor and use of a loading apparatus. For example, a conveyor may be configured to provide compressible material 50 and to load the compressible material 50 into the metering bin 14. The method may further include the step of determining the amount of the compressible material 50 to be compressed. For example, the metering bin 14 may be configured to determine an amount of compressible material 50 to be compressed in the baling device 10. For example, the metering bin 14 may include a weighing device for determining an amount of compressible material 50 to be compressed, as discussed above.

The method may further include the step of transferring the amount of the compressible material 50 to be compressed from the metering bin 14 into the staging bin 16. For example, the metering bin 14 may be configured to selectively transfer the amount of compressible material 50 to be compressed to the staging bin 16. The metering bin 14 may include a chute 41 and at least one transfer mechanism 42, as discussed above.

The method may further include the step of loading compressible material 50 into a staging bin 16. For example, the staging bin 16 may be configured to accommodate an amount of compressible material 50 to be compressed, as determined by the metering bin 14 and selectively transferred from the metering bin 14 to the staging bin 16. The compressible material 50 that is selectively transferred from the metering bin 14 to the staging bin 16 may be loaded into the staging bin 16.

The method may further include the step of transferring the compressible material 50 from the staging bin 16 into a feed bin 18. For example, the staging bin 16 may be configured to selectively transfer the compressible material 50 to the feed bin 18, as shown in FIGS. 1B, 1D, and 2. The staging bin may include a feed gate 46 and at least one reciprocating device 47, as discussed above. The staging bin 16 may also include a spreading mechanism 48 for distributing the compressible material 50 within the staging bin 16, as discussed above.

The method may further include the step of loading the compressible material 50 from the feed bin 18 into a compression chamber disposed in a compression position 80 adjacent the feed bin 18. For example, the compression chamber may be one of a first compression chamber 20 and a second compression chamber 22. The first and second compression chambers 20 and 22 may each define a bore 24 and 26 therethrough. As discussed above, the first compression chamber 20 and the second compression chamber 22 may be rotatable about an axis 85 between the compression position 80 and a transfer position 82 spaced from the feed bin 18. The axis 85 may be a substantially horizontal axis. The baling device 10 may include a compression rain 30 configured to load the compressible material 50 from the feed bin 18 into a respective one of the first or second compression chambers 20 or 22 when the respective chamber is disposed in the compression position 80, as discussed above and shown in FIGS. 1C and 1E. The compression ram 30 may include a head 34 and a shaft 35, as discussed above.

The method may further include the step of compressing the compressible material 50 into a bale 60 within the compression chamber 20 or 22 disposed in the compression position 80. For example, the baling device 10 may include a compression barrier 40, as discussed above. The compression ram 30 may be configured to compress the compressible material 50 into a bale 60 within the respective compression chamber 20 or 22 disposed in the compression position 80, as discussed above and shown in FIGS. 1C and 1E.

If desired, the step of loading the compressible material 50 from the feed bin 18 into the compression chamber 20 or 22 disposed in the compression position 80 and the step of compressing the compressible material 50 into a bale 60 within the compression chamber 20 or 22 disposed in the compression position 80 may occur simultaneously. For example, the step of loading the compressible material 50 from the feed bin 18 into the respective compression chamber 20 or 22 and the step of compressing the compressible material 50 into a bale within the respective compression chamber 20 or 22 may both occur upon each movement of the head 34 from the first position to the second position.

Operation of the compression ram 30 to simultaneously load and compress the compressible material allows for a faster and more efficient compression and baling process, wherein multiple steps of the process can be performed simultaneously.

If desired, the step of transferring the compressible material 50 into the feed bin 18 and the step of loading the compressible material 50 from the feed bin 18 into the compression chamber 20 or 22 disposed in the compression position 80 may occur in sequence. For example, the staging bin 16 may be configured to selectively transfer the compressible material 50 to the feed bin 18, as discussed above. Further, the compression ram 30 may be configured to reciprocate between a first position and a second position, as discussed above. The feed gate 46 of the staging bin 16 may be configured such that, upon withdrawal of the compression rain 30 from the second position to the first position, the feed gate 46 opens, transferring the compressible material 50 into the feed bin 18. The feed gate 46 may further be configured such that, upon movement of the compression ram 30 from the first position to the second position, the feed gate 46 closes, such that the staging bin 16 may accommodate compressible material 50. Thus, the staging bin 16 may operate to transfer the compressible material 50 into the feed bin 16 in sequence with operation of the compression rain 30 to load the compressible material 50 from the feed bin 18 into the compression chamber 20 or 22 disposed in the compression position 80.

Operation of the staging bin 16 and the compression ram 30 in sequence allows for staging of the compressible material 50 in the baling device 10. For example, the compressible material 50 is held in the staging bin 16 during movement of the compression ram 30 from the first position to the second position, and is transferred from the staging bin 16 to the feed bin 18 upon withdrawal of the compression ram 30 from the second position to the first position. Staging of the compressible material 50 in the staging bin 16 during operation of the compression ram 30 minimizes or eliminates any delay in the reciprocal operation of the compression ram 30 to load and compress the compressible material 50. This allows for a faster and more efficient baling process.

The method may further include the step of rotating the compression chamber 20 or 22 about the axis 85 to the transfer position 82. For example, the axis 85 may be a substantially horizontal axis. The compression chambers 20 and 22 may rotate about the axis 85 from a compression position 80 to a transfer position 82, as shown in FIG. 1D.

If desired, the step of loading the compressible material from the feed bin 18 into the compression chamber 20 or 22 disposed in the compression position 80 and the step of rotating the compression chamber 20 or 22 about the axis 85 to the transfer position 82 may occur in sequence. For example, the compression ram 30 may be configured to reciprocate between a first position and a second position, loading the compressible material 50, as discussed above. The compression chambers 20 and 22 may be configured such that, upon withdrawal of the compression rain 30 from the second position to the first position, the compression chambers 20 and 22 are rotated about the axis 85. For example, the compression chambers 20 and 22 may be rotated about the axis 85 such that the respective compression chamber 20 or 22 disposed in the compression position 80 is rotated to the transfer position 82 and the respective compression chamber 20 or 22 disposed in the transfer position 82 is rotated to the compression position 80. The compression chambers 20 and 22 may further be configured such that, during movement of the compression ram 30 from the first position to the second position, the compression chambers 20 and 22 are held stationary in the respective compression 80 and transfer 82 positions. Thus, rotation of the compression chamber 20 or 22 about the axis 85 to the transfer position 82 may occur in sequence with loading of the compressible material 50 from the feed bin 18 into the compression chamber 20 or 22 disposed in the compression position 80.

The method may further include the step of ejecting the bale 60 from the compression chamber 20 or 22 disposed in the transfer position 82. For example, the baling device 10 may include a transfer ram 32 configured to eject the bale 60 from the respective one of the first or second compression chambers 20 or 22 when the respective transfer chamber is disposed in the transfer position 82, as discussed above. The transfer ram 32 may include a head 36 and a shaft 37, as discussed above.

If desired, the step of ejecting the bale 60 from the respective first or second compression chamber 20 or 22 disposed in the transfer position 82 and the step of loading the compressible material 50 from the feed bin 18 into the respective second or first compression chamber 22 or 20 disposed in the compression position 80 occur simultaneously. For example, the compression ram 30 and the transfer rain 32 may be configured to reciprocate between respective first positions and respective second positions simultaneously, as discussed above. Thus, the head 36 of the transfer ram 32 may reciprocate between a first position and a second position, ejecting the bale 60 from the respective compression chamber 20 or 22, while the head 34 of the compression ram 30 reciprocates between a first position and a second position, loading the compressible material 50 from the feed bin 18 into the respective compression chamber 22 or 20.

It should be understood that, if desired, the step of loading the compressible material 50 from the feed bin 18 into the respective second or first compression chamber 22 or 20 disposed in the compression position 80, the step of compressing the compressible material 50 into a bale 60 within the respective second or first compression chamber 22 or 20 disposed in the compression position 80, and the step of ejecting the bale 60 from the respective first or second compression chamber 20 or 22 disposed in the transfer position 82 may all occur simultaneously, as discussed in detail above.

Operation of the compression ram 30 and the transfer ram 32 simultaneously to load and compress the compressible material 50 and eject the bale 60 allows for a faster and more efficient compression and baling process, wherein multiple steps of the process can be performed simultaneously.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A baling device for compressing compressible material into a bale, the device comprising:
a frame;
a staging bin mounted to the frame and configured to accommodate the compressible material;
a feed bin mounted to the frame and configured to receive the compressible material from the staging bin;
a first compression chamber and a second compression chamber mounted to the frame so as to be rotatable about a substantially horizontal axis, the first compression chamber and the second compression chamber each rotatable about the axis between a compression position adjacent the feed bin and a transfer position spaced from the feed bin; and
a compression ram configured to load the compressible material from the feed bin into a respective one of the first or second compression chambers when the respective compression chamber is disposed in the compression position, and to compress the compressible material into the bale within the respective compression chamber.

2. The baling system of claim 1, wherein the compression ram includes a head and a shaft, the head configured to reciprocate between a first position within the feed bin and a second position within the respective one of the first or second compression chambers when the respective compression chamber is disposed in the compression position.

3. The baling device of claim 1, wherein the operation of the compression ram to load the compressible material and the operation of the compression ram to compress the compressible material occur simultaneously.

4. The baling device of claim 1, further comprising a transfer ram configured to eject the bale from a respective one of the first or second compression chambers when the respective compression chamber is disposed in the transfer position.

5. The baling device of claim 4, wherein the transfer ram includes a head and a shaft, the head configured to reciprocate between a first position adjacent to the respective one of the first or second compression chambers and a second position within the respective one of the first or second compression chambers when the respective compression chamber is disposed in the transfer position.

6. The baling device of claim 5, wherein the operation of the transfer ram to eject the bale and the operation of the compression ram to load the compressible material occur simultaneously.

7. The baling device of claim 1, wherein the first compression chamber and the second compression chamber each define a bore therethrough.

8. The baling device of claim 1, further comprising a compression barrier fixedly mounted to the frame and situated adjacent the respective one of the first or second compression chambers when the respective compression chamber is disposed in the compression position, wherein the compression ram compresses the compressible material into the bale within the respective compression chamber and against the compression barrier.

9. The baling system of claim 1, wherein the staging bin includes a feed gate configured to selectively transfer the compressible material to the feed bin.

10. The baling system of claim 1, wherein the staging bin further includes at least one spreading mechanism configured to distribute the compressible material within the staging bin.

11. The baling system of claim 1, further comprising a metering bin configured to determine an amount of the compressible material to be compressed and to selectively transfer the amount of the compressible material to be compressed to the staging bin.

12. A method for compressing compressible material into a bale, the method comprising:
loading compressible material into a staging bin;
transferring the compressible material from the staging bin into a feed bin;
loading the compressible material from the feed bin into a compression chamber disposed in a compression position adjacent the feed bin, wherein the compression chamber is one of a first compression chamber and a second compression chamber, the first compression chamber and second compression chamber rotatable about a substantially horizontal axis between the compression position and a transfer position spaced from the feed bin;
compressing the compressible material into the bale within the compression chamber disposed in the compression position;
rotating the compression chamber about the axis to the transfer position; and
ejecting the bale from the compression chamber disposed in the transfer position.

13. The method of claim 12, wherein the loading of the compressible material from the feed bin into the compression chamber disposed in the compression position and the compressing of the compressible material occur simultaneously.

14. The method of claim 12, wherein the ejecting of the bale from the respective first or second compression chamber disposed in the transfer position and the loading of the compressible material from the feed bin into the respective second or first compression chamber disposed in the compression position occur simultaneously.

15. The method of claim 12, wherein loading the compressible material from the feed bin into the compression chamber disposed in the compression position and rotating the compression chamber about the axis to the transfer position occur in sequence.

16. The method of claim 12, wherein transferring the compressible material into the feed bin and loading the compressible material from the feed bin into the compression chamber disposed in the compression position occur in sequence.

17. The method of claim 12, further comprising loading the compressible material into a metering bin.

18. The method of claim 17, further comprising determining an amount of the compressible material to be compressed.

19. The method of claim 18, further comprising transferring the amount of the compressible material to be compressed from the metering bin into the staging bin.

20. A baling device for compressing compressible material into a bale, the device comprising:
a frame;
a staging bin mounted to the frame and configured to accommodate the compressible material;
a feed bin mounted to the frame and configured to receive the compressible material from the staging bin; and
means for simultaneously loading the compressible material from the staging bin and compressing the compressible material into a bale.

21. The baling device of claim 20, further comprising means for simultaneously loading the compressible material from the staging bin and ejecting the bale.
